(19) United States
(12) Patent Application Publication
(10) Pub. No.: US 2010/0237687 A1
(43) Pub. Date: Sep. 23, 2010

(54) ARRANGEMENT FOR VENTING OF HYDRAULIC SYSTEM IN MOTOR VEHICLE

(76) Inventor: Nael Al-madanat, Spanga (SE)

Correspondence Address: BROOKS KUSHMAN P.C., 1000 TOWN CENTER, TWENTY-SECOND FLOOR, SOUTHFIELD, MI, 48075, US

(21) Appl. No.: 12/303,860

(22) PCT Filed: Apr. 5, 2007
(86) PCT No.: PCT/SE2007/000326

§ 371 Date: Dec. 8, 2008

(30) Foreign Application Priority Data
Jun. 8, 2006 (SE) 0601267-8

(51) Int. Cl. B60T 17/00

(52) U.S. Cl. 303/6.01

(57) ABSTRACT

An arrangement for venting of a hydraulic circuit, particularly a hydraulic brake circuit for a vehicle, comprises a master cylinder which via a pipe system communicates with a number of slave cylinders each arranged to act upon a respective powered unit, such as a brake, for a vehicle wheel, whereby each slave cylinder has a venting nipple with a closable venting valve. The arrangement comprises a venting valve with an associated drain line connectable to the nipple and comprising a check valve which opens towards the receiving vessel. The drain line has a branch line comprising a check valve which opens towards the nipple, and the branch line is connected to a storage vessel for fresh hydraulic fluid.

The invention relates to an arrangement for venting of a hydraulic circuit, particularly a hydraulic brake circuit, in a vehicle, of the kind indicated in the preamble of the attached independent claim.

Hydraulic circuits, particularly hydraulic brake circuits, comprise conventionally a master cylinder which via a pipe system communicates with a number of slave cylinders each arranged to act upon a respective unit, particularly a brake for a motor vehicle, whereby each slave cylinder has a venting nipple comprising an openable and closable venting valve, and the arrangement comprises a receiving vessel with a drain line connectable to a slave cylinder nipple and comprising a check valve which opens towards the receiving vessel.

A problem with previously known venting arrangements is that they rely on the master cylinder and an associated hydraulic fluid storage facility being used for pumping new hydraulic fluid in the system towards the particular slave cylinder being vented. This entails the master cylinder tending to disintegrate during relatively rapid pumping of the master cylinder, i.e. the brake pedal of the brake system.

An object of the invention is therefore to provide an arrangement which reduces the risk of damage to the master cylinder during venting of slave cylinders.

A further object is to provide an arrangement which has two different vessels, namely a vessel which only delivers fresh hydraulic fluid and another vessel which only receives old hydraulic fluid.

A further object of the invention is to propose an arrangement which allows rapid and easy connection of the arrangement and rapid and easy venting of respective slave cylinders.

Further objects and advantages are indicated in the description set out below.

These objects are achieved fully or partly by the invention.

The invention is indicated in the attached independent claim.

Embodiments of the invention are indicated in the attached dependent claims, the description set out below and the attached drawing.

The invention is described below in example form with reference to the attached drawing.

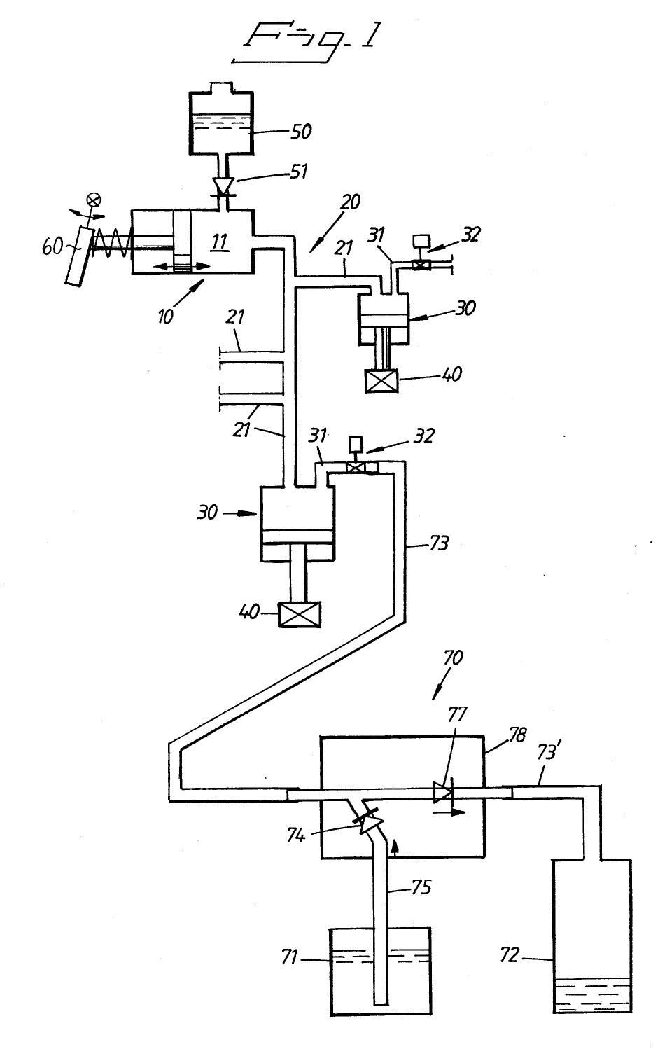

FIG. 1 depicts schematically a hydraulic brake circuit for a vehicle and, connected to it, a venting arrangement.

FIG. 1 depicts a hydraulic brake circuit for a vehicle whereby the circuit comprises a master cylinder 10 whose fluid-filled space 11 communicates with respective slave cylinders 30 via a pipeline system 20 and branch pipes 21. Each slave cylinder 30 may be assumed to have its piston and piston rod connected to an associated running brake 40 for a vehicle wheel.

Each slave cylinder 30 has a nipple 31 which preferably connects to the uppermost part of the portion of the slave cylinder 30 which is filled with fluid. The nipple 31 is illustrated in the form of a pipeline section and comprises a valve 32 which can open and close.

The master cylinder 10 is depicted with an associated storage vessel 50 of hydraulic fluid, which vessel 50 communicates with the fluid space of the master cylinder 10 via a check valve 51 which opens towards the master cylinder 10.

The piston and piston rod of the master cylinder 10 are directly or indirectly connected to a foot-operated brake pedal 60 which is normally loaded towards a state of rest in which the fluid space 11 has its greatest volume.

A venting arrangement 70 for the hydraulic brake circuit comprises a receiving vessel 72 for old brake fluid driven out of the system. A line 73 has its one end portion 73′ accommodated in the upper part of the vessel 72 and its other end connected to the free end of the nipple 31. The line 73 is provided with a check valve 77 situated between the end of the line 73 which connects to the vessel 72 and a branch line 75 leading from the line 73. The branch line 75 comprises a check valve 74 which opens towards the line 73. The branch line 75 extends down to the bottom region of a storage vessel 71 containing fresh hydraulic fluid.

The volume of the lines 73, 75 is preferably much smaller than the maximum swept volume of the master cylinder 10. It is also preferable that the check valve 74 be arranged to open at a lower pressure drop than across the check valve 51 between the master cylinder and the storage reservoir 50.

When the line 73 is tightly connected to the nipple 31 and the valve 32 is opened, the piston of the master cylinder is acted upon by, for example, the brake pedal 60, whereby air and possibly also fluid are driven out of the slave cylinder 30 to the receiving vessel 72 via the line 73, 73′ and the check valve 77. When the pedal 60 and the piston revert in the master cylinder 10, fresh hydraulic fluid is drawn into the slave cylinder 30 from primarily the storage vessel 71 via the branch line 75 and the check valve 74, the nipple 31 and the valve 32. As there is a relatively large difference in the volume of the chamber 10 as between the extreme positions of the piston, effective replacement of hydraulic fluid in the system by the arrangement 70 involves relatively few pumping operations by the master cylinder 10.

As illustrated in FIG. 1, the two check valves 74, 77 may be fitted in a common equipment housing 78 which may have fixed pipes corresponding to the enclosed portions of the line sections 73 and 75, whereby these pipes have end sections which protrude from the enclosure 78 and to which the arrangement's external line portions are connected. These external line portions may be in the form of hoses.

A storage vessel for hydraulic fluid, e.g. the storage vessel 71, may be connected by a hose (not depicted) to the storage vessel 50 of the master cylinder 10 to allow hydraulic fluid to be drawn across to the vessel 50 in order to prevent the fluid level in the vessel 50 from falling below a lower limit value. The hose between the vessels 50 and 71 may have a closable valve (not depicted).

The storage vessel 71 may be situated at a higher level than the storage vessel 50 of the master cylinder 10. The vessels 71, 72, 50 are ventilated in a conventional manner to allow air inflow and outflow in order respectively to prevent below and above atmospheric pressure in these vessels.

1. An arrangement for venting of a hydraulic circuit, particularly a hydraulic brake circuit for a vehicle, whereby the circuit comprises a master cylinder which via a pipe system communicates with a number of slave cylinders each arranged to act upon a respective powered unit, such as a brake, for a vehicle wheel, whereby each slave cylinder has a venting nipple with a closable venting valve and the arrangement comprises a receiving vessel with an associated drain line connectable to the nipple and itself comprising a check valve which opens towards the receiving vessel, characterised in that the drain line has a branch line comprising a check valve which opens towards the nipple, and that the branch line is connected to a storage vessel for fresh hydraulic fluid.

2. An arrangement according to claim 1, characterised in that the master cylinder is connected to a reservoir of fresh hydraulic fluid which can be drawn into the master cylinder via a check valve which opens towards the master cylinder, and that the check valve in the branch line to the arrangement's storage vessel of fresh hydraulic fluid is arranged to open at a lower pressure difference than the check valve between the master cylinder and its associated reservoir of hydraulic fluid.

3. An arrangement according to claim 1, characterised in that the volume of the arrangement's lines is much smaller than the maximum pumping volume of the master cylinder in one working stroke.

4. An arrangement according to claim 1, characterised in that the check valves belonging to the drain line and the branch line are fitted in an equipment housing which has fixed pipe portions protruding from it and allowing the connection of hose sections which provide communication to the slave cylinder's nipple and to hoses leading into the respective storage reservoirs.

5. An arrangement according to claim 2, characterised in that the volume of the arrangement's lines is much smaller than the maximum pumping volume of the master cylinder in one working stroke.

6. An arrangement according to claim 2, characterised in that the check valves belonging to the drain line and the branch line are fitted in an equipment housing which has fixed pipe portions protruding from it and allowing the connection of hose sections which provide communication to the slave cylinder's nipple and to hoses leading into the respective storage reservoirs.

7. An arrangement according to claim 3, characterised in that the check valves belonging to the drain line and the branch line are fitted in an equipment housing which has fixed pipe portions protruding from it and allowing the connection of hose sections which provide communication to the slave cylinder's nipple and to hoses leading into the respective storage reservoirs.
